(19) United States
(12) Patent Application Publication
(10) Pub. No.: US 2010/0203190 A1
(43) Pub. Date: Aug. 12, 2010

(54) COATED CONFECTIONERY PRODUCTS

(75) Inventors: David G. Barkalow, Deerfield, IL (US); Michael A. Reed, Merrillville, IN (US); Elena S. Mirzoeva, Cary, IL (US)

Correspondence Address: K&L Gates LLP, P.O. Box 1135, CHICAGO, IL, 60690, US

(73) Assignee: WM. WRIGLEY JR. COMPANY, Chicago, IL (US)

(21) Appl. No.: 12/526,913

(22) PCT Filed: Feb. 11, 2008
(86) PCT No.: PCT/US08/53577

§ 371 Date: Apr. 27, 2010

Related U.S. Application Data
(60) Provisional application No. 60/889,387, filed on Feb. 12, 2007.

(51) Int. Cl. A23G 3/54; A23G 4/20; A23P 1/08

(52) U.S. Cl. 426/5; 426/89; 426/103; 426/302; 426/293

(57) ABSTRACT

Coated confectionery products and methods of making the coated confectionery products are provided. In a general embodiment, the present disclosure provides a confectionery product comprising a confectionery center, and a coating comprising erythritol and an anti-crystallizing agent surrounding the confectionery center. For example, the weight ratio of the erythritol to the anti-crystallizing agent in the coating can be between about 20:80 and about 80:20.

### BACKGROUND

The present disclosure relates generally to confectionery products. More specifically, the present disclosure relates to polyol-based coatings for confectionery products including, for example, chewing gum products and candy and methods of preparing the coated confectionery products.

Confectionery products and chewing gum, for example, in pellet form, are frequently enclosed with a hard or soft coating. Coatings provide an opportunity for the manufacturer to vary product characteristics such as taste, appearance, structure and nutritional value. Coatings can be made from a variety of sugar and sugarless syrups. However, applying coatings to confectionery products can be problematic. For example, the coating syrups may comprise ingredients that crystallize very quickly thereby causing processing problems such as plugging of the coating syrup supply line or spray nozzles during the coating process.

### SUMMARY OF THE INVENTION

The present disclosure is directed to coated confectionery products and methods of making the coated confectionery products. In a general embodiment, the present disclosure provides a confectionery product comprising a confectionery center, and a coating comprising erythritol and an anti-crystallizing (e.g. crystallizing inhibiting) agent surrounding the confectionery center. For example, the anti-crystallizing agent mitigates or moderates the crystallization of erythritol so that it can be utilized more readily in confectionery coating processes.

In an embodiment, the weight ratio of the erythritol to the anti-crystallizing agent in the coating is between about 20:80 and about 80:20.

In an embodiment, the weight ratio of the erythritol to the anti-crystallizing agent in the coating is between about 40:60 and about 60:40.

In an embodiment, the weight ratio of the erythritol to the anti-crystallizing agent in the coating is approximately 50:50.

In an embodiment, the anti-crystallizing agent is hydroxypropyl methyl cellulose.

In an embodiment, the anti-crystallizing agent is gum tahla (i.e. gum arabic).

In an embodiment, the anti-crystallizing agent is selected from the group consisting of polydextrose, inulin, fructooligosaccharide, carboxymethyl cellulose, microcrystalline cellulose, hydrolyzed guar gum, pyrolized dextrins (e.g. indigestible dextrins) and combinations thereof.

In an embodiment, the anti-crystallizing agent is maltitol.

In an embodiment, the anti-crystallizing agent is a polyol selected from the group consisting of xylitol, sorbitol, mannitol, isomalt, lactitol and combinations thereof, The polyols can be in any suitable form such as, for example, powders or syrups.

In an embodiment, the confectionery center can be, for example, jelly candies, pressed tablets, mints, chewy candies, hard boiled candies, chocolates, nougats, licorice, taffy, gels, solid foam, crystallized pastes, rework or combinations thereof.

In an embodiment, confectionery center can be a chewing gum comprising a form such as, for example, pellets, sticks, tabs, dragees, chicklets, batons or combinations thereof.

In an embodiment, the confectionery center comprises one or more ingredients such as, for example, malted products, sweeteners, flavors, colors, sensates, acids, medicaments, actives or combinations thereof.

In an embodiment, the coating comprises one or more ingredients such as, for example, malted products, sweeteners, flavors, colors, sensates, acids, medicaments, actives and combinations thereof.

In another embodiment, the present disclosure provides a method of making a confectionery product. The method comprises providing a confectionery center, and coating the confectionery center with one or more layers of a coating syrup comprising erythritol and an anti-crystallizing agent.

In an embodiment, the method further comprises adding a dry charge to the confectionery center after a layer of the coating syrup has been applied.

In an embodiment, the dry charge can be, for example natural carbohydrate gum hydrolysates, maltodextrin, gelatin, cellulose derivatives, starches, modified starches, sugars, polyols, talc, calcium carbonate or combinations thereof.

In an alternative embodiment, the present disclosure provides a method of making a confectionary product. The method comprises providing a confectionary center, and applying to the confectionery center a plurality of coating layers. One or more of the coating layers comprises a coating syrup comprising erythritol and an anti-crystallizing agent.

In an embodiment, applying the coating layers to the confectionery center can be done by spraying upon, pouring over or combinations thereof.

In an embodiment, each of the coating layers are dried before another coating layer is applied.

In an embodiment, the method further comprises adding a dry charge to the confectionery center after one or more coating layers have been applied.

An advantage of the present disclosure is to provide improved coated confectionery products.

Another advantage of the present disclosure is to provide improved methods for making coated confectionery products.

Yet another advantage of the present disclosure is to reduce the blockage of coating syrup supply lines and spray nozzles during the coating process.

Still another advantage of the present disclosure is to increase provide a cost-effective method of coating confectionery products with erythritol.

Additional features and advantages are described herein, and will be apparent from, the following Detailed Description.

### DETAILED DESCRIPTION

The present disclosure relates to coated confectionery products and methods of preparing such coated confectionery products. Generally, the coatings of the present disclosure comprise erythritol. The erythritol coatings can be non-cariogenic and tooth-friendly. The erythritol coatings can be low in calories and provide a reduced laxative effective. The coatings of the present disclosure can be used on any suitable confectionery products such as, for example, soft and hard candies and chewing gums.

Coating syrups may comprises ingredients such as, for example, certain polyols that tend to crystallize very quickly. In particular, erythritol crystallizes at a fast rate. For example, coating confectionery products with syrups comprising erythritol leads to frequent clogging of the syrup spray nozzles and the syrup transportation supply lines that feed into the spray nozzles. This reduces the efficiency and increases the costs of the coating processes using erythritol-based syrups due to the need for repeated cleaning and/or unclogging of the coating equipment.

Applicants having surprisingly discovered that the use of anti-crystallization agents mitigates the crystallization of erythritol-based coating syrups thereby leading to reduced clogging of the nozzles and the supply lines. At the same time, the final erythritol coatings of the present disclosure have sufficient hardness and are similar in crunch and appearance to other polyol coatings.

In a general embodiment, the present disclosure provides a confectionery product comprising a confectionery center, and a coating comprising erythritol and one or more anti-crystallizing (e.g. crystallizing inhibiting) agents surrounding the confectionery center. The coating can partially, substantially or entirely surround the confectionery center.

The anti-crystallizing agent can be any suitable ingredient that mitigates or slows down erythritol crystal formation. For example, the anti-crystallizing agent can be hydroxypropyl methyl cellulose, gum tahla (i.e. gum arabic) or combinations thereof. The anti-crystallizing agent can also be polydextrose, inulin, fructooligosaccharide, carboxymethyl cellulose, microcrystalline cellulose, hydrolyzed guar gum, pyrolized dextrins (e.g. indigestible dextrins) or combinations thereof.

Pyrolized or indigestible dextrins are modified maltodextrins with very low reducing sugar content. Varieties are sold under the trade names of FIBERSOL® and NUTRIOSE®. FIBERSOL® is marketed by Fibersol America, a division of Matsutani Chemical Industry Co., Ltd of Hyogo-Pref., Japan. NUTRIOSE® is marketed by Roquette Freres of Lestrem, France.

In another embodiment, the anti-crystallizing agent can be a polyol such as maltitol. The anti-crystallizing agent can also be a polyol such as xylitol, sorbitol, mannitol, isomalt, lactitol or combinations thereof. It should be appreciated that the polyols can be in any suitable form such as, for example, powders or syrups.

In an embodiment, the weight ratio of the erythritol to the one or more anti-crystallizing agents in the coating is between about 20:80 and about 80:20. In another embodiment, the weight ratio of the erythritol to the one or more anti-crystallizing agents in the coating is between about 40:60 and about 60:40. In an alternative embodiment, the weight ratio of the erythritol to the one or more anti-crystallizing agents in the coating is approximately 50:50.

The coatings of the present disclosure can be used to coat any suitable confectionery centers. For example, the confectionery center can comprise jelly candies, pressed tablets, mints, chewy candies, hard boiled candies, chocolates, nougats, licorice, taffy, gels, solid foam, crystallized pastes, rework or combinations thereof. The confectionery center can also comprise a chewing gum in a form such as, for example, pellets, sticks, tabs, dragees, chicklets, batons or combinations thereof.

The coating can initially be present as a liquid syrup which contains from about 30% to about 80% or 85% of the suitable coating ingredients, and from about 15% or 20% to about 70% of a solvent such as water. The erythritol-based coating syrups of the present disclosure may include non-polyol ingredients which are commonly used in sugar and sugarless coatings. The specific ingredients and their usage levels will vary greatly according to the intentions for the formulation.

The use of one or more fillers (e.g., titanium dioxide, calcium carbonate, silicon dioxide) in the present disclosure may be advantageous. In this regard, these inorganic materials aid the coating process by giving the polyol-based syrup coatings a smoother finish. Furthermore, these inorganic fillers enhanced the ease with which polyols could be used, and in many instances substantially increase the crunchiness of the product.

In another embodiment, the present disclosure provides a method of making a confectionery product. The method comprises providing a confectionery center, and coating the confectionery center with a layer of a coating syrup comprising erythritol and an anti-crystallizing agent. Generally, such coating layers can be applied by, for example, spraying the coating syrups onto the confectionery centers. Spraying can be alternately started and stopped to allow layers of coating to dry onto the surface of the pieces. Forced air and dry powder additionally may be used to speed the drying process. The various parameters of the operation (spray time, dry time, air temperature, tumbling speed and others) will vary greatly from one system to another and may well vary within a coating batch and from batch to batch. They will be set based on the skill and experience of the developer and operator. Typical coating equipment usable in the present disclosure will include any suitable apparatus normally used for this purpose.

The syrup can be added to the confectionery centers at a temperature of from about 100° F. to about 240° F. Preferably, the syrup temperature is from about 140° F. to about 200° F. Most preferably, the syrup temperature should be kept constant throughout the process. In another embodiment, the syrup can be maintained at a temperature that will not melt the confectionery centers while the confectionery centers are being coated. The syrup may be mixed with, sprayed upon, poured over, or added to the confectionery center in any way known to those skilled in the art.

In some instances, a soft coating is formed by adding a dry charge or powder coating after a liquid coating. The dry charge may comprise natural carbohydrate gum hydrolysates, maltodextrin, gelatin, cellulose derivatives, starches, modified starches, sugars, sugar alcohols (i.e. polyols), natural carbohydrate gums and fillers like talc and calcium carbonate.

Each component of the coating on the confectionery center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the confectionery centers. Preferably, no more than about 75 coats are applied to the confectionery centers. More preferably, less than about 60 coats are applied and most preferably, about 30 to 60 coats are applied. In any event, the present disclosure contemplates applying an amount of syrup sufficient to yield a coated confectionery product containing about 10% to about 65% coating by weight of the total confectionery product. In an embodiment, the final confectionery product will comprise at least 30% coating by weight of the total confectionery product.

In another embodiment, once a coating of syrup is applied to the confectionery center, drying is performed on the wet syrup in an inert medium. A preferred drying medium comprises air. Preferably, drying air contacts the wet syrup coating in a temperature range of from about 70° F. to about 110° F. More preferably, the drying air is in the temperature range of from about 80° F. to about 100° F. The disclosure also contemplates that the drying air can possess a relative humidity of less than about 15 percent. Preferably, the relative humidity of the drying air used between syrup applications is less than about 8 percent.

The drying air may be passed over and admixed with the syrup coated confectionery centers in any way commonly known in the art. Preferably, the drying air is blown over and around the syrup coated confectionery centers at a flow rate, for large scale operations, of about 2800 cubic feet per minute. If lower quantities of material are being processed, or if smaller equipment is used, lower flow rates would be used. If a flavor is applied after a syrup coating has been dried, the present disclosure contemplates drying the flavor with or without the use of a drying medium.

In addition to the coatings of the present disclosure applied by spraying, optionally, flavors may be separately sprayed onto the pieces during the coating process to provide a flavored coating. If used, this flavor may constitute from about 0.01 to 3% of the total coating with levels of 0.5 to 2% being preferred. Flavors may be added before, during and after applying the syrup to the confectionery center.

Optionally, a final polishing coat may be applied to the pieces after the coatings have been applied. The polishing coat may use a wax, such as carnauba wax, or shellac. It may also include fillers such as talc and colors. The polishing coat can be typically 0.1 to 0.5% by weight of the total coating.

Confectionery and Coating Ingredients

It should be appreciated that one or more ingredients such malted products, flavors, sensates, colors (e.g. azo free colors), sweetener, acids, actives and medicaments (e.g. listed below) can go into the coatings or the confectionery centers of the present disclosure. The ingredients can be added in a free form. The ingredients can also be part of an encapsulation, compaction, granulation and agglomeration to provide, for example, protected and longer-lasting ingredient components such as flavors and sensates. It should also be appreciated that any or all of the layers (e.g. coatings, confectionery centers) can comprise any suitable number, amounts and combinations of the malted products, flavors, sweeteners (including high intensity), sensates, acids, actives and/or medicaments.

Sugar sweeteners generally may include saccharide-containing components commonly known in the confectionery art, including, but not limited to, sucrose, dextrose, maltose, dried invert sugar, fructose, levulose, tagatose, galactose, corn syrup solids, and the like, alone or in combination. Alternatively, sweeteners may include glycerin, fruit concentrates and fruit pastes.

Maltitol may be used as a sugarless sweetener. Additionally, sugarless sweeteners may include, but are not limited to, other sugar alcohols such as xylitol, sorbitol, erythritol, mannitol, isomalt, lactitol, hydrogenated starch hydrolysates, and the like, alone or in combination.

High intensity artificial or natural sweeteners may also be used in combination with the above. Preferred high intensity sweeteners include, but are not limited to sucralose, neotame, aspartame, salts of acesulfame, alitame, saccharin and its salts, cyclamic acid and its salts, stevioside, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics. Usage level of the artificial sweetener can vary greatly and will depend on such factors as potency of the sweetener, rate of release, desired sweetness of the product, level and type of flavor used and cost considerations.

Combinations of sugar and/or sugarless sweeteners may be used in the confectionery. If a low calorie confectionery is desired, a low caloric bulking agent can be used. Example of low caloric bulking agents include: Raftilose; Raftilin; Palatinose oligosaccharide; Guar Gum Hydrolysate (SUN FIBER®). However, other low calorie bulking agents can be used.

The flavorant or flavor used in the confectionery products may include any natural or synthetic oil and/or flavor as is commonly known in the art. Natural and artificial flavoring agents may be combined in any sensorially acceptable fashion. The flavor agents can be used in any suitable amount in the confectionery products.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors may also include any suitable pastes, powders and extracts of fruits and/or vegetables. Alternatively, flavors types may salty, meaty, potato chip, etc.

It is understood that these flavorants may be used alone or in combination with or without a sensate such as, for example, a cooling or heating agent as is commonly known in the art. The flavorant or flavor may be encapsulated or non-encapsulated. Encapsulated flavorant may be used to increase or decrease the flavor release rate as is commonly known in the art.

Generally, sensates may be any compounds cause a cooling, heating, warming, tingling or numbing, for example, to the mouth or skin. Non-limiting examples of coolants include menthol substituted p-menthane carboxamides, acyclic carboxamides, menthone glycerol ketals, menthyl lactate, menthyl succinate, 3-1-menthoxypropane-1,2 diol, and spearmint. Non-limiting examples of heating agents may include vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same. Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, actives may include, inter alia, anti-oxidants, vitamins, minerals, stimulants, prebiotics, probiotics, enzymes, genetically modified organisms, nutritional supplements, yoghurt ingredients and whitening ingredients. Generally, medicaments may include, inter alia, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. It is envisioned, that depending on the medicament, the resultant product can be used to treat, inter alia: coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (n-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins may include Vitamins A, B-complex (such as B-1, B-2, B-6 and B-12), C, D, E and K, niacin and acid vitamins such as pantothenic acid and folic acid and biotin. Minerals may include calcium, iron, zinc, magnesium, iodine, copper, phosphorus, manganese, potassium, chromium, molybdenum, selenium, nickel, tin, silicon, vanadium and boron.

Specific medicaments may include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine and insulin.

In an alternative embodiment, the confectionery centers can comprise a chewing gum composition having a water-soluble bulk portion, a water-insoluble chewable gum base portion and typically water-insoluble flavoring agents. For example, the water-soluble portion dissipates with a portion of the flavoring agent over a period of time during chewing. The gum base portion can be retained in the mouth throughout the chew.

The chewing gum center can also comprise materials that allow it to be suitably combined with other confectioneries. For example, the chewing gum can be chocolate/fat tolerant, acid friendly, tack-free, etc.

Chewing gum generally consists of a water insoluble gum base, a water soluble portion, and flavors. The insoluble gum base generally comprises elastomers, resins, fats and oils, softeners, and inorganic fillers. The gum base may or may not include wax. The insoluble gum base can constitute approximately 5 to about 95 percent, by weight, of the chewing gum shell, more commonly, the gum base comprises 10 to about 50 percent of the gum, and in some preferred embodiments, 20 to about 35 percent, by weight, of the chewing gum.

In an embodiment, the chewing gum of the present disclosure contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called ester gums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, sensates, acidulants, fillers, antioxidants, preservatives, actives, medicaments (as previously described) and other suitable components or processing aids or combinations thereof that provide desired attributes as known by the skilled artisan.

Softeners can be added to the chewing gum in order to optimize the chewability and mouth feel of the gum. The softeners, which are also known as plasticizers and plasticizing agents, generally constitute between approximately 0.5 to about 15% by weight of the chewing gum. The softeners may include caprenin, glycerin, lecithin and combinations thereof. Aqueous sweetener solutions such as those containing sorbitol, hydrogenated starch hydrolysates, corn syrup, other polyols or sugars, such as tagatose, and combinations thereof, may also be used as softeners and binding agents in chewing gum.

A variety of processes for manufacturing chewing gum center are possible as is known in the art. For example, chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time, along with syrup and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed.

### EXAMPLES

By way of example and not limitation, the following examples are illustrative of various embodiments of the present disclosure and further illustrate experimental testing conducted with the confectionary coatings in accordance with embodiments of the present disclosure.

### Example 1

### Stability Evaluations

The following experiments were performed to evaluate stability of erythritol coating syrups. In a first syrup stability test, the following ingredients listed in Table 1 were mixed together to form coating syrups.

TABLE 1
Syrup Stability Test #1

| | Percent Dry Basis (Experiment #) | | | | | | | |
|---|---|---|---|---|---|---|---|---|
| Ingredient | # 1 | # 2 | # 3 | # 4 | # 5 | # 6 | # 7* | # 8 |
| Erythritol | 86.7 | 81.7 | 78.7 | 86.7 | 76.7 | 81.7 | 84.7 | 86.7 |
| Gum tahla | 12.5 | 12.5 | 12.5 | 0 | 12.5 | 12.5 | 12.5 | 0 |
| Sorbitol | 0 | 5 | 0 | 0 | 0 | 0 | 0 | 0 |
| Maltitol syrup | 0 | 0 | 8 | 0 | 0 | 0 | 0 | 0 |
| Hydroxypropyl | 0 | 0 | 0 | 12.5 | 0 | 0 | 0 | 0 |
| Starch | | | | | | | | |
| C* Osan starch | 0 | 0 | 0 | 0 | 0 | 0 | 0 | 12.5 |
| Calcium | 0 | 0 | 0 | 0 | 10 | 0 | 0 | 0 |
| carbonate | | | | | | | | |
| Mannitol | 0 | 0 | 0 | 0 | 0 | 5 | 0 | 0 |
| Titanium | 0.8 | 0.8 | 0.8 | 0.8 | 0.8 | 0.8 | 0.8 | 0.8 |
| dioxide | | | | | | | | |
| Methyl- | 0 | 0 | 0 | 0 | 0 | 0 | 2.0 | 0 |
| cellulose | | | | | | | | |
| Temperature | 75 | 75 | 75 | 75 | 75 | 75 | 75 | 75 |
| (° C.) | | | | | | | | |
| Brix | 70 | 70 | 70 | 70 | 70 | 70 | 70 | 70 |

*dissolve the methylcellulose in water first and then add erythritol.

The syrup samples were held at the indicated temperature and stirred every 15 minutes. The time was recorded when crystallized layer formed on top of solution, or upon other indications of crystallization. Separately, the thick layer of syrup was drawn down on foil or glass, and the time it took to crystallize (plus any observations) was recorded to measure the syrup stability. The results of the syrup stability tests are shown in Table 2.

TABLE 2
Results from Syrup Stability Test #1

| Exp. # | Syrup Stability Results |
|---|---|
| #1 | unstable has crystal layer on rim (Crystallizes |
| | as soon as stop stirring) |
| #2 | unstable has crystal layer on rim (Crystallizes |
| | as soon as stop stirring) |
| #3 | unstable has crystal layer on rim (Crystallizes |
| | as soon as stop stirring) |
| #4 | slightly less crystals on rim (−4 sec. after |
| | stop stirring) |
| #5 | unstable has crystal layer on rim (Crystallizes |
| | as soon as stop stirring) |
| #6 | slightly less crystals on rim (−6 sec. after |
| | stop stirring) |
| #7 | unstable has crystal layer on rim (Crystallizes |
| | as soon as stop stirring) |
| #8 | unstable has crystal layer on rim (Crystallizes |
| | as soon as stop stirring) |

A second stability test was performed using the ingredients listed in Table 3 and the results of the stability test are listed in Table 4.

TABLE 3
Syrup Stability Test #2

| | Percent Dry Basis (Experiment #) | | | | | | |
|---|---|---|---|---|---|---|---|
| Ingredient | # 9 | # 10 | # 11 | # 12 | # 13 | # 14 | # 15 |
| Erythritol | 76.7 | 66.7 | 76.7 | 76.7 | 66.7 | 85.7 | 56.2 |
| Gum tahla | 12.5 | 12.5 | 12.5 | 12.5 | 12.5 | 12.5 | 12.5 |
| Sorbitol | 10 | 20 | 0 | 0 | 0 | 0 | 30 |
| Maltitol syrup | 0 | 0 | 10 | 0 | 0 | 0 | 0 |
| Maltitol | 0 | 0 | 0 | 10 | 20 | 0 | 0 |
| Titanium dioxide | 0.8 | 0.8 | 0.8 | 0.8 | 0.8 | 0.8 | 0.8 |
| Sodium | 0 | 0 | 0 | 0 | 0 | 1 | 0 |
| carboxymethyl- | | | | | | | |
| cellulose | | | | | | | |
| Temperature (° C.) | 75 | 75 | 75 | 75 | 75 | 75 | 75 |
| Brix | 70 | 70 | 70 | 70 | 70 | 70 | 70 |

TABLE 4
Results from Syrup Stability Test #2

| Exp. # | Syrup Stability Results |
|---|---|
| #9 | unstable has crystal layer on rim (crystallizes |
| | as soon as stop stirring) |
| #10 | unstable has crystal layer on rim (crystallizes |
| | as soon as stop stirring) |
| #11 | unstable has crystal layer on rim (crystallizes |
| | as soon as stop stirring) |
| #12 | unstable has crystal layer on rim (crystallizes |
| | as soon as stop stirring) |
| #13 | Syrup at this level has less crystal layer on |
| | rim (−6 sec. after stop stirring) |
| #14 | unstable has crystal layer on rim |
| #15 | Syrup has less crystal layer and less than Exp. |
| | 12 (−8 sec. after stop stirring) |

A third stability test was performed using the ingredients listed in Table 5 and the results of the stability test are listed in Table 6.

TABLE 5
Syrup Stability Test #3

| | Percent Dry Basis (Experiment #) | | | |
|---|---|---|---|---|
| Ingredient | #16 | #17 | #18 | #19 |
| Erythritol | 43.4 | 52 | 60.7 | 69.3 |
| Gum tahla | 12.5 | 12.5 | 12.5 | 12.5 |
| Sorbitol | 0 | 0 | 0 | 0 |
| Maltitol syrup | 0 | 0 | 10 | 0 |
| Maltitol | 43.3 | 34.7 | 26 | 17.3 |
| Titanium dioxide | 0.8 | 0.8 | 0.8 | 0.8 |
| Sodium | 0 | 0 | 0 | 0 |
| carboxymethylcellulose | | | | |
| Temperature (° C.) | 75 | 75 | 75 | 75 |
| Brix | 70 | 70 | 70 | 70 |

TABLE 6
Results from Syrup Stability Test #3

| Exp. # | Syrup Stability Results |
|---|---|
| #16 | Shows No crystal layer on rim (−5 min. |
| | shows slightly small thin crystal layer |
| | after stop stirring) |
| #17 | Slightly crystal showing around wall of |
| | container and not on center rim (−4 min. |
| | shows small crystal layer after stop |
| | stirring) |
| #18 | More crystals and starts to form thin |
| | layer on rim (−2 min. shows small crystal |
| | layer after stop stirring) |
| #19 | Unstable medium thick crystal layer on |
| | rim (once stop stirring, shows crystal |
| | layer on rim) |

### Example 2

### Sensory Evaluations

Coated chewing gum pellets having coatings comprising a polyol ratio of: 1) 60/40 erythritol/maltitol, and 2) 50/50 erythritol/maltitol were compared to a control maltitol coated chewing gum pellet comprising 100% maltitol as the polyol ingredient. The 60/40 erythritol/maltitol coated formula was most similar to the 100% maltitol coated control pellet for crunchy texture and cooling action. The control coating and the 60/40 erythritol/maltitol coating formula elicited cooling action in the mouth (peak moderate to high), nose (peak moderate), and throat (peak moderate). Cooling levels were slightly lower for the 50/50 erythritol/maltitol formula. Sweetness levels were similar across the 3 samples.

### Example 3

### Confectioneries

TABLE 7
Chewy Confectionery with Erythritol Coating

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Dextrin | 225 |
| | Water | 85 |
| | Maltitol syrup | 65 |
| | Erythritol | 105 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

TABLE 8
Chewy Confectionery with Erythritol Coating

| Chewy | | |
|---|---|---|
| Confectionery | Ingredients | Amount (grams) |
| A | Gelatin (250 bloom) | 11.3 |
| | Gum Arabic | 1.4 |
| | Water | 22.5 |
| B | Polydextrose | 290 |
| | Water | 85 |
| | Maltitol syrup | 65 |
| | Erythritol | 40 |
| C | Fat | 29 |
| | Emulsifier | 1.25 |
| | Lecithin | 1.25 |
| D | Erythritol (finely ground) | 20 |
| | Sensate | 2.8 |
| | High intensity sweetener #1 | 0.64 |
| | High intensity sweetener #2 | 0.27 |
| | Color | 0.16 |

Coating

| | Amount (grams) |
|---|---|
| Ingredients | (per 100 g centers) |
| Erythritol | 215 |
| Gum tahla | 75 |
| Water | 100 |
| Titanium dioxide | 2.5 |
| Sensate | 0.2 |

Brix = 60
Temperature = 75° C.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A confectionery product comprising:
a confectionery center; and
a coating comprising erythritol and an anti-crystallizing agent surrounding the confectionery center.

2. The confectionery product of claim 1, wherein the weight ratio of the erythritol to the anti-crystallizing agent in the coating is between about 20:80 and about 80:20.

3. (canceled)

4. The confectionery product of claim 1, wherein the weight ratio of the erythritol to the anti-crystallizing agent in the coating is approximately 50:50.

5-6. (canceled)

7. The confectionery product of claim 1, wherein the anti-crystallizing agent is selected from the group consisting of polydextrose, inulin, fructooligosaccharide, carboxymethyl cellulose, microcrystalline cellulose, hydrolyzed guar gum, pyrolized dextrins, hydroxypropyl methyl cellulose, gum tahla and combinations thereof.

8. (canceled)

9. The confectionery product of claim 1, wherein the anti-crystallizing agent is a polyol selected from the group consisting of maltitol, xylitol, sorbitol, mannitol, isomalt, lactitol and combinations thereof

10. The confectionery product of claim 1, wherein the confectionery center is selected from the group consisting of chewing gum, jelly candies, pressed tablets, mints, chewy candies, hard boiled candies, chocolates, nougats, licorice, taffy, gels, solid foam, crystallized pastes, rework and combinations thereof.

11-13. (canceled)

14. A method of making a confectionery product, the method comprising:
providing a confectionery center; and
coating the confectionery center with a layer of a coating syrup comprising erythritol and an anti-crystallizing agent.

15. The method claim 14, wherein the weight ratio of the erythritol to the anti-crystallizing agent in the coating is between about 20:80 and about 80:20.

16. (canceled)

17. The method of claim 14, wherein the anti-crystallizing agent is selected from the group consisting of polydextrose, inulin, fructooligosaccharide, carboxymethyl cellulose, microcrystalline cellulose, hydrolyzed guar gum, pyrolized dextrins, hydroxypropyl methyl cellulose, gum tahla and combinations thereof.

18. (canceled)

19. The method of claim 14, wherein the anti-crystallizing agent is a polyol selected from the group consisting of maltitol, xylitol, sorbitol, mannitol, isomalt, lactitol and combinations thereof.

20. The method of claim 14, wherein the confectionery center is selected from the group consisting of chewing gum, jelly candies, pressed tablets, mints, chewy candies, hard boiled candies, chocolates, nougats, licorice, taffy, gels, solid foam, crystallized pastes, rework and combinations thereof.

21. (canceled)

22. The method of claim 14, further comprising adding a dry charge to the confectionery center after a layer of the coating syrup has been applied.

23. The method of claim 22, wherein the dry charge is elected from the group consisting of natural carbohydrate gum hydrolysates, maltodextrin, gelatin, cellulose derivatives, starches, modified starches, sugars, polyols, talc, calcium carbonate and combinations thereof.

24. A method of making a confectionery product, the method comprising:
providing a confectionery center; and
applying to the confectionery center at least one coating layer comprising erythritol and an anti-crystallizing agent selected from the group consisting of hydroxypropyl methyl cellulose, gum tahla, carboxymethyl cellulose, hydrolyzed guar gum, pyrolized dextrins, inulin, xylitol, sorbitol, mannitol, isomalt, lactitol, maltitol and combinations thereof.

25. The method of claim 24, wherein the step of applying the coating layers to the confectionery center is chosen from the group consisting of spraying upon, pouring over and combinations thereof.

26. (canceled)

27. The method of claim 24, further comprising adding a dry charge to the confectionery center after a coating layer has been applied.

28. The method of claim 27, wherein the dry charge is selected from the group consisting of natural carbohydrate gum hydrolysates, maltodextrin, gelatin, cellulose derivatives, starches, modified starches, sugars, polyols, talc, calcium carbonate and combinations thereof.
